(19) United States
(12) Patent Application Publication
(10) Pub. No.: US 2006/0019693 A1
(43) Pub. Date: Jan. 26, 2006

(54) Method for effecting wireless communication between radio stations and device for carrying out the method

(76) Inventors: Peter Kopetzky, Unterhaching (DE); Jurgen Lehmann, Riedenburg (DE); Matthias Schneider-Hufschmidt, Munchen (DE)

Correspondence Address: BELL, BOYD & LLOYD, LLC, P. O. BOX 1135, CHICAGO, IL, 60690-1135, US

(21) Appl. No.: 10/519,213

(22) PCT Filed: Jun. 18, 2003
(86) PCT No.: PCT/DE03/02039

§ 371 Date: Mar. 10, 2005

(30) Foreign Application Priority Data
Jun. 20, 2002 (DE) 102 27 557.2

(51) Int. Cl. H04B 7/00

(52) U.S. Cl. 455/522; 455/69; 455/67.13; 455/74.1

(57) ABSTRACT

The present invention is based on the fundamental idea that, in many applications, the intended communication partner differs, such as by his position or other features, which are easily influenced by the user, from all other potential and unintended communication partners (third parties) in such a manner that the transmission features of the contactless interface (that is, for example, of the radio channel) between him/her and a first radio station (FS1), which is seeking to set up the connection, fulfill a specified quality criterion that is not fulfilled by all other potential communication partners or in such a manner that such a difference in the transmission features can be brought about at least by modifying at least one operating parameter of the first radio station (FS1).

### BACKGROUND OF THE INVENTION

The small dimensions of modern communication terminals, coupled with the high performance capability of the components used in their processors and memories, make them suitable for the most widely diverse mobile applications which, in the first instance, have nothing at all to do with their main application, telecommunications. Such applications include, among others, those referred to as “point-of-sale applications”, that is, those in which the device mainly fulfils the functions of an electronic way of payment, and also include security applications, in which the device acts for purposes of identification or authentication. In the final analysis, “point-of-sale applications” are simply special cases of the security applications, possibly with some additional design features, since in an electronic payment procedure it is usual for the payee and often also the payer to need to prove the identity and authorization of the other party.

Other small devices, such as those known as personal digital assistants (PDA), with or without a telecommunication module, are also mostly suitable for such applications, provided they have a suitable interface for data transmission. Most of these interfaces have been known for a long time. Examples include infrared interfaces or short-range interfaces such as those made to the “bluetooth” standard.

Short-range contactless (“wireless”) data transmission interfaces are particularly suitable for local communication. For this type of application they have the advantage that, from the outset, the group of possible communication partners is restricted to the immediate surroundings, which is often a fairly small area. Even today temporary connections can be established between PDAs for the purpose of transferring “electronic visiting cards” or other data by placing these PDAs in very close proximity and/or pointing their infrared interfaces towards one another. One then can be reasonably certain (which for many applications is sufficient) that the communication which is taking place is actually with the required communication partner.

This known method is often insufficient for applications with greater security requirements. There would be too great a danger that an unseen or unnoticed third party could break into the intended purely bilateral communication without first being detected, and data could be exchanged with a communication partner other than the communication partner required. The present invention is, therefore, directed toward remedying this situation.

### SUMMARY OF THE INVENTION

Accordingly, a method is provided for effecting wireless communication between radio stations in which a purely bilateral communication connection or a purely bilateral communication relationship is to be established between a first radio station and only one particular second radio station out of a group of second radio stations, such that at least one operating parameter of the first radio station is changed with the aim of influencing the transfer characteristics between the radio stations wherein, as a result of changing the at least one operating parameter, the transfer characteristics of only one particular radio connection of the first station to the only one particular second radio station fulfill a defined quality criterion.

In an embodiment of the present invention, a device is provided for carrying out the method as described above.

Additional features and advantages of the present invention are described in, and will be apparent from, the following Detailed Description of the Invention and the Figures.

### BRIEF DESCRIPTION OF THE FIGURES

FIG. 1 shows a diagram of a typical application situation and its solution according to the present invention.

FIG. 2 is a diagram showing the manner of processing the special case in which, from the outset, only a second radio station is located in the vicinity of the first radio station.

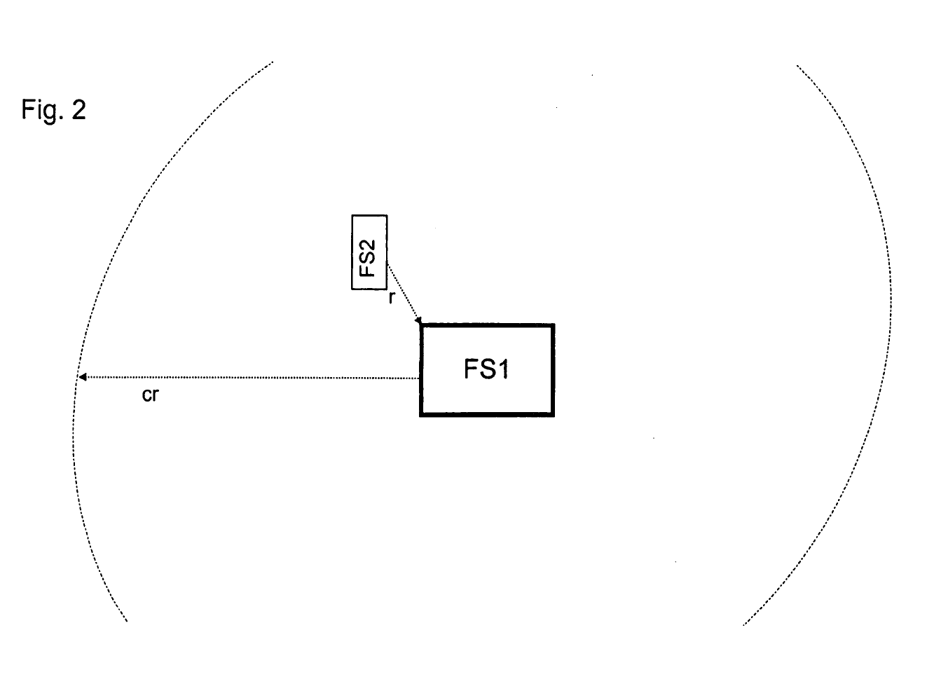

### DETAILED DESCRIPTION OF THE INVENTION

The present invention is based on the fundamental idea that, in many applications, the intended communication partner differs, such as by his/her position or other features, which are easily influenced by the user, from all other potential and unintended communication partners (third parties) in such a manner that the transmission features of the contactless interface (that is, for example, of the radio channel) between him/her and a first radio station (FS1), which is seeking to set up the connection, fulfil a specified quality criterion that is not fulfilled by all other potential communication partners or in such a manner that such a difference in the transmission features can be brought about at least by modifying at least one operating parameter of the first radio station (FS1).

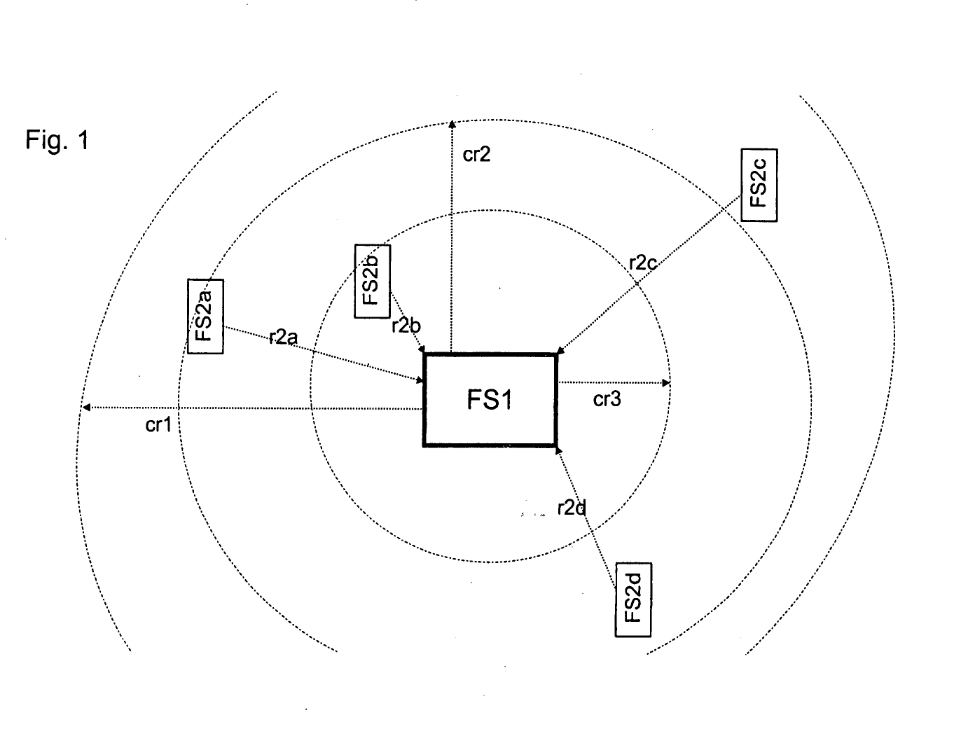

A simple and typical example of such a situation is shown in FIG. 1. In the vicinity of the first radio station (FS1), which intends to establish a connection with a second radio station, are several second radio stations (FS2a to FS2d). The first radio station could be part of a cash-desk system in a department store, for example. The second radio stations (FS2a to FS2d) may be thought of as mobile telephones or other small devices which are all able to make contact with the first radio station (FS1). These second radio stations are usually in the possession of different people who, as a rule, are customers or potential customers of the store.

One of these customers approaches the radio station (FS1) of the cash-desk system in order to pay for a chosen item with the aid of the second radio station (FS2b). In order for the payment transaction to proceed correctly, it is now very important that a purely bilateral connection or relationship for communication purposes be established and maintained between the radio stations (FS1 and FS2b) of the rightful participants in the payment transaction. Otherwise, it easily would be possible for third parties to break in such that the correct processing of such wireless payment transactions could not be guaranteed.

This is because the radio station FS1 cannot initially “know” how to recognize the radio station FS2b of any given customer. Therefore, it would be relatively easy for any third party to operate their own radio station in such a way that the cash-desk system carries out the payment transaction on the third-party radio station, when it might even be a refund in the course of exchanging goods.

However, as the diagram in FIG. 1 shows, the radio station FS2b is now distinguished from all other radio stations by being the closest to the cash-desk system (FS1). Consequently, it should be possible to change the transmission power or the reception sensitivity of the radio station FS1 in such a way that a connection or relationship for communication purposes is possible only with this one radio station FS2b.

This can be achieved, for instance, by gradually reducing the transmission power or reception sensitivity of the radio station FS1 in the cash-desk system. For this purpose, the first radio station (FS1) could transmit a first call signal or connection request signal (cr1) initially at a fairly high transmission power so that it has enough range for all four of the second radio stations shown in FIG. 1 to be able to receive this signal. In this step, all four second radio stations then each transmit a response signal (r2a to r2d), so that if the initial reception sensitivity is high enough, all four response signals can be received by the first radio station FS1.

In the next step, the transmission power of the first radio station FS1 now can be reduced on a trial basis. Alternatively, the reception sensitivity could be reduced. It also would be possible to reduce both quantities at the same time.

If the corresponding operating parameters are chosen appropriately, then after no more than a few such steps at least one of the four second radio stations will cease to respond or its response no longer will be received by the first radio station. For example if the transmission power is reduced so far that the connection request signal cr2 no longer reaches the second radio station FS2c, that radio station stops responding. The other three second radio stations (FS2a, FS2b and FS2d) continue to respond, however, because they can receive the signal cr2. Then, in the next step, the transmission power of the first radio station FS1 could be reduced further so that, for example, only FS2b continues to respond, or the reception sensitivity could be reduced to the extent that only the response from FS2b can be received.

However, the transmission power could be reduced further, so that a third connection request signal cr3 no longer reaches the second radio stations FS2a, FS2c and FS2d, but still reaches the second radio station FS2b. In this case, only the second radio station FS2b would still transmit a response r2b which the first radio station FS1 could receive.

In more general terms, in practically all situations in which the distance ratios or propagation ratios between the individual radio stations are sufficiently different, it will be possible to set suitable operating parameters of the first radio station FS1 in such a way that a connection or relationship for communication purposes exists or can be maintained only with one particular second radio station.

At certain places in this patent application a distinction is made between a connection for communication purposes and a relationship for communication purposes. The reason for this is that the term (communication) connection is frequently used for situations in which useful data is actually transmitted. The somewhat more general term (communication) relationship is intended to express that frequently such a transfer of useful data is not really necessary in order to achieve the purpose of the present invention. In many cases, it is enough that, for example, the receive field strength at the receiver reaches or exceeds a minimum value. If this applies to only one particular second radio station FS2b, it is then possible to speak of a purely bilateral communication relationship between this particular second radio station FS2b and the first radio station FS1, even though a communication connection in the narrower sense of the word does not actually exist. In the particular context of the description of the present invention therefore, both terms occasionally are to be understood in such a way that either term could stand for the other.

It is, for example, possible to use the application to establish a communication connection between a cash-desk system (ST) having a wireless module and a customer device (CD) having a wireless module (WM); in particular, with a mobile telephone (MP). Generally several people with such customer devices are to be found in a sales area, for instance waiting in a queue at the cash desk. For a particular payment transaction, the cash-desk system wishes to make contact exclusively with the customer device closest to the cash desk. This, in fact, makes it very easy to ensure that it is actually the customer device of the customer currently paying which is taking part in the electronic payment transaction and not the device of another customer in the cash-desk queue or elsewhere in the sales area.

It is an advantage of the method according to the present invention that no participating device needs to know anything about the address or identifier of any other device. Using such addresses or identifiers is, of course, another way of ensuring that only the “correct” devices take part in the payment transaction. For example, anyone using the system could perhaps manually enter into the cash-desk system a device identifier for the customer device taking part in the payment transaction, this identifier being unknown to anyone else present. This would be very complicated for the applications being considered. It is, therefore, an advantage of the method according to the present invention that this complicated and possibly error-prone procedure can be dropped.

The cash-desk system or, in more general terms, a service terminal (ST) can instead transmit a device address or device identification directly over the radio path to the actual customer device concerned once the communication relationship between both is truly bilateral. By using such a device address, which could be temporary, that is to say only valid for the current payment transaction, the communication then can be secured against inadvertent interference or third-party attack, even should the criterion of the shortest physical distance no longer be fulfilled after this protection has been established. The method according to the present invention does not require an address to be input from outside, that is, other than via the radio path.

The customer actually involved in the payment transaction thus has to bring the mobile telephone or other customer device close to the cash-desk or service terminal only once and then can move further away, even while the payment transaction is still in progress. This characteristic of the present invention makes the process of handling the payment transaction significantly more convenient for the people involved.

A further advantageous application of the present invention is possible in connection with logging subscriber stations (SM) onto base stations (BS) of cellular or other wireless communication systems; in particular, cordless telephone systems according to the DECT standard. When systems of this kind are being started up for the first time or additional subscriber stations such as those acquired subsequently are used, any subscriber stations that have not yet been logged onto the system must first be logged on.

This normally takes place in the context of a log-on procedure which, in principle, carries with it the risk that, unknown to the authorized user, unauthorized third parties could also log onto the system. This is because the base station cannot “know” how to recognize the authorized user's subscriber station. In general, however, it is very easy for an authorized user intending to carry out the log-on procedure to go to the area in which the base station is located and approach the base station so closely that it is virtually impossible for any device used by an eavesdropper to be closer to the base station than the device operated by the authorized user.

Therefore, if more than one device is located in the area of the base station during the log-on procedure, the base station need simply reduce its transmission power, for example, until just one communication with the subscriber device to be logged on is still possible. This method also has the advantage that the devices concerned can identify each other directly via the external interface (i.e., via the radio channel) without transmitting any identification information externally.

Although the present invention has been described with reference to specific embodiments, those of skill in the art will recognize that changes may be made thereto without departing from the spirit and scope of the present invention as set forth in the hereafter appended claims.

1-14. (canceled)

15. A method for effecting wireless communication between radio stations in which one of a purely bilateral communication connection and a purely bilateral communication relationship is to be established between a first radio station and only one particular second radio station of a plurality of second radio stations, the method comprising:
changing at least one operating parameter of the first radio station with an aim of influencing transfer characteristics between the radio stations; and
fulfilling a defined quality criterion, as a result of changing the at least one operating parameter, via the transfer characteristics of only one particular radio connection of the first radio station to the only one particular second radio station.

16. A method for effecting wireless communication between radio stations as claimed in claim 15, wherein the at least one operating parameter to be changed is a transmission power of the first radio station.

17. A method for effecting wireless communication between radio stations as claimed in claim 15, wherein the at least one operating parameter to be changed is a reception sensitivity of the first radio station.

18. A method for effecting wireless communication between radio stations as claimed in claim 15, wherein the defined quality criterion consists of exceeding a minimum receive field strength at the first radio station.

19. A method for effecting wireless communication between radio stations as claimed in claim 15, wherein the at least one operating parameter of the first radio station is initially chosen so that a plurality of the second radio stations fulfill the defined quality criterion, and wherein the at least one operating parameter is further changed in steps until ultimately the only one particular second radio station still fulfills the defined quality criterion.

20. A method for effecting wireless communication between radio stations as claimed in claim 15, wherein the first radio station is a service terminal having a radio module, the plurality of second radio stations are a plurality of customer devices having radio modules, and a communication connection of the service terminal is established with only one particular customer device of the plurality of customer devices which is closest to the service terminal.

21. A method for effecting wireless communication between radio stations as claimed in claim 20, wherein the service terminal initially knows nothing about an address or identifier of the particular customer device, the particular customer device initially knows nothing about an address or identifier of the service terminal, and even in subsequent stages of communication between the service terminal and the particular customer device, no addresses or identifiers are input from outside.

22. A method for effecting wireless communication between radio stations as claimed in claim 20, wherein the service terminal is a cash-desk system, and each of the plurality of customer devices is one of a mobile telephone and an information technology device.

23. A method for effecting wireless communication between radio stations as claimed in claim 15, wherein the first radio station is a base station of a wireless communication system, the plurality of second radio stations are a plurality of subscriber stations of the wireless communication system, and a communication connection of the base station is established with only one particular subscriber station of the plurality of subscriber stations which is closest to the base station.

24. A method for effecting wireless communication between radio stations as claimed in claim 23, wherein the base station initially knows nothing about an address or identifier of the particular subscriber station, the particular subscriber station initially knows nothing about the address or identifier of the base station, and even in subsequent stages of communication between the base station and the particular subscriber station, no addresses or identifiers are input from outside.

25. A method for effecting wireless communication between radio stations as claimed in claim 23, wherein each of the plurality of subscriber stations is one of a mobile telephone, a cordless telephone and an information technology device.

26. A method for effecting wireless communication between radio stations as claimed in claim 15, further comprising transmitting a signal, via at least one of the participating radio stations, containing information about one of the radio station concerned and a user of the radio station concerned.

27. A method for effecting wireless communication between radio stations as claimed in claim 15, the method further comprising:
transmitting, via the first radio station, a request to send a response; and
reducing a range of the transmit signal until only a response of a single second radio station is still received, thus ensuring that only the single second radio station can be located in the transmission range of the first radio station.

28. A method for effecting wireless communication between radio stations as claimed in claim 27, wherein the range of the transmit signal is reduced by lowering a transmission power.

29. A method for effecting wireless communication between radio stations as claimed in claim 27, wherein the range of the transmit signal is reduced via shielding with aid of a mechanical plug-in device.

30. A device for effecting wireless communication between radio stations in which one of a purely bilateral communication connection and a purely bilateral communication relationship is to be established between the device and only one particular further device of a plurality of further devices, comprising:
a radio module for sending and receiving electromagnetic signals; and
a device for controlling at least one operating parameter of the radio module, which can influence transfer characteristics of a radio connection such that, as a result of changing the at least one operating parameter, the transfer characteristics of only one particular radio connection of the device to only one particular further device of a plurality of further devices fullfil a defined quality criterion.
